(19) United States
(12) Patent Application Publication
(10) Pub. No.: US 2023/0002201 A1
(43) Pub. Date: Jan. 5, 2023

(54) Discharge beater removal install device

(71) Applicants: Stephen William Anderson, Rochelle, IL (US); Michael D. Reints, Linderwood, IL (US)

(72) Inventors: Stephen William Anderson, Rochelle, IL (US); Michael D. Reints, Linderwood, IL (US)

(21) Appl. No.: 17/300,441

(22) Filed: Jul. 2, 2021

(51) Int. Cl. B66D 3/18; A01F 12/40; B62B 3/10; B23P 19/04

(52) U.S. Cl. CPC B66D 3/18; A01F 12/40; B62B 3/10; B23P 19/04; A01D 41/1243

(57) ABSTRACT

The present invention relates to servicing a harvester discharge beater and, more particularly, to remove and install the discharge beater without disassembly inside the harvester.

### FIELD OF THE INVENTION

The present invention relates to servicing a harvester discharge beater and, more particularly, removing and installing the discharge beater without disassembly inside the harvester.

### BACKGROUND OF THE INVENTION

Harvesting of crops has always resulted in the need for harvester maintenance. One of the maintenance items is the discharge beater located in the rear lower portion of the harvester. The discharge beater is made of steel and is very heavy, 300 to 400 pounds. Discharge beaters often include wear strips on the corn and small-grain base machines, providing extended wear life. On the John Deere series 70 harvester, for example, the discharge beater's fixed speed of 840 rpm on the five-wing and the 10-wing discharge beater design moves material quickly away from the rear of the separator through the discharge housing. It is this fast speed and constant friction against crops like corn and wheat that create the wear.

The discharge beater is positioned in an exceedingly difficult to access location making its removal difficult in its assembled condition. The discharge beater wears with use and must be replaced. It also may suffer from damage-causing breakage requiring repair. The harvester cannot operate if the discharge beater is not up to standards meaning the harvester incurs downtime until the discharge beater can be replaced.

Removing it creates additional problems connected with harvest speed. All crops have an ideal harvest period. Financial prudence dictates that a crop is harvested within that window at the lowest possible cost. This means limiting the number of mechanical harvesters used to bring in the crop. Modern harvesters cost many hundreds of thousands of dollars and require a skilled operator to run them through the fields. Therefore, the faster a harvester can collect the crop from the field, the lower the harvesting cost.

Therein lies the second problem, the discharge beater until now has required two strong persons on average 5 hours each to remove and replace a discharge beater. Harvester operators do not have an abundance of available labor, especially during harvest requiring they hire additional help or incur the downtime of another person to repair the discharge beater.

The third problem is safety. The discharge beater located in the rear lower section of the harvester in a difficult place to reach must be manually lifted from its location. Even a strong person bent over in tight quarters strains to lift a 300-to-400-pound discharge beater from its cradle. Installing it is currently done using 2″×12″ planks to lift and guide the discharge beater into place, risking injury to the mechanics. A slip or board breakage could easily result in severe injury to the mechanics. In addition, a back injury can quickly occur from straining to lift the heavy discharge beater. Crushing of hands or fingers while guiding the discharge beater into place is another significant risk.

Solutions for removing and installing the discharge beater have existed since the first discharge beater was invented. They include total disassembly and brute force to remove and or install a discharge beater. In addition, working inside the rear of a harvester in cramped quarters with many sharp edges and other dangerous surroundings is uncomfortable, time-consuming, and hazardous.

It would be advantageous to provide a means to remove and replace the discharge beater effortlessly.

It would also be advantageous to remove and replace the discharge beater safely.

It would also be advantageous to remove and replace the discharge beater with only one person.

It would further be advantageous to provide a faster way to remove and replace the discharge beater.

### SUMMARY OF THE INVENTION

In accordance with the present invention, there is provided a removal/install tool that permits the easy one-person removal and install of a harvester discharge beater.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a side view of the right rear of a harvester with a discharge beater removal tool and cart showing the beater just being removed from its harvester cradle.

FIG. 2 is a side view of the right rear of a harvester with a discharge beater removal tool and cart showing the beater in the lowered position.

FIG. 3 is a side view of the right rear of a harvester with a discharge beater removal tool and cart showing the beater in the removed position.

FIG. 4 is a front view of a two-section drum.

FIG. 5 is a front and end view of a spool pipe.

For purposes of clarity and brevity, like elements and components will bear the same designations and numbering throughout the Figures.

### DETAILED DESCRIPTION OF THE INVENTION

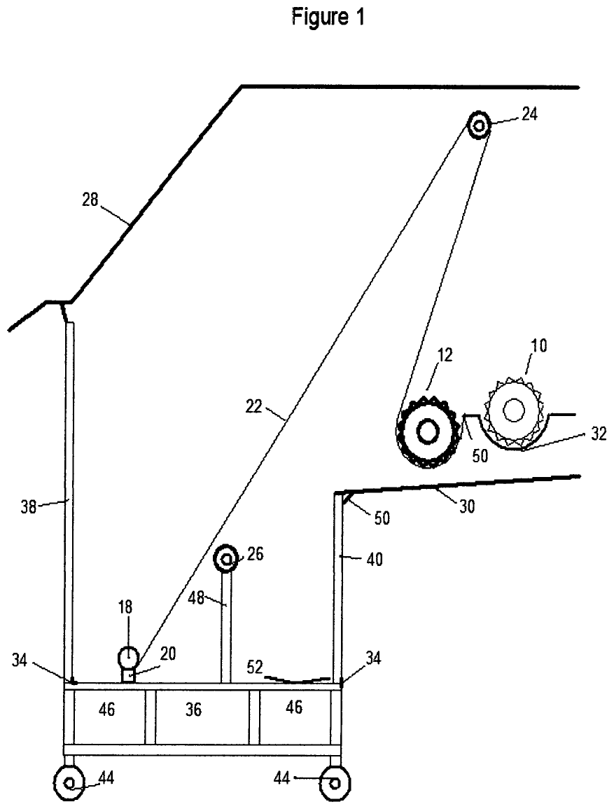

FIG. 1 is a side view of the right rear of a harvester with a discharge beater removal tool and cart showing the beater, 10 just removed from its harvester beater cradle, 32.

The discharge beater removal install device's purpose is to remove and install a harvester beater, 10 easier and safer. However, the beater, 10, is very heavy, and the workspace confined, creating a challenging and hazardous working situation. Therefore, in a preferred version of this invention, there is a winch, 18. That is mounted to a cart, 36. This cart permits the invention to be moved into a convenient location to assist in removing the beater, 10. Or to move the new beater, 10, into place for installation into the rear of the combine.

The winch, 18, is equipped with a two-section drum, 60. That permits the use of two belts, 22. The Belts are attached at one end to the winch drum, 60, and at the other end at various points within the harvester or cart, 36, as needed for the task being performed.

In the removal process, the belts are attached at the rear of the harvester deck, 30 utilizing a hook, 50. The beater, 10, is rolled rearward into the belts, 22, which create a cradle for the beater, 12, which can then be lowered into the cart, 36, beater cradle, 52.

The winch, 18, operator controls the winch, 18, by means of a remote control (now shown) so that they remain safely out of harm's way.

The cart, 36, uses the harvester deck, 30, and the Chopper housing, 28, to stabilize itself. The roller pipe, 24, is secured to the top sides of the inside of the rear of the harvester to provide a lifting point from which to extract or install the beater, 10.

The discharge beater, 10, install removal device may also be mounted to other frames, or even receiver hitches commonly found on the rear of pickup trucks to be used to remove or replace other heaver parts safely and easily and is not limited to combining harvesters.

For installation, the beater, 10, is lifted back into position utilizing the belts, 22 attached to the winch, 18. When the beater, 10, is near its installed position in the rear of the combine, it is rolled the rest of the way into place.

To make movement of the cart easier forklift holes, 46, have been incorporated into the design of the cart, 36. It should be noted that other options may be incorporated into the cart, 36, such as booms (not shown) to permit the cart to be used to lift other heavy objects not associated with a harvester. Such object may for example be other heavy agricultural machinery or parts, boats, trailers, and other objects to heavy or difficult for a person to manage on their own. The Cart, 36, may also be motorized in another version of the present invention.

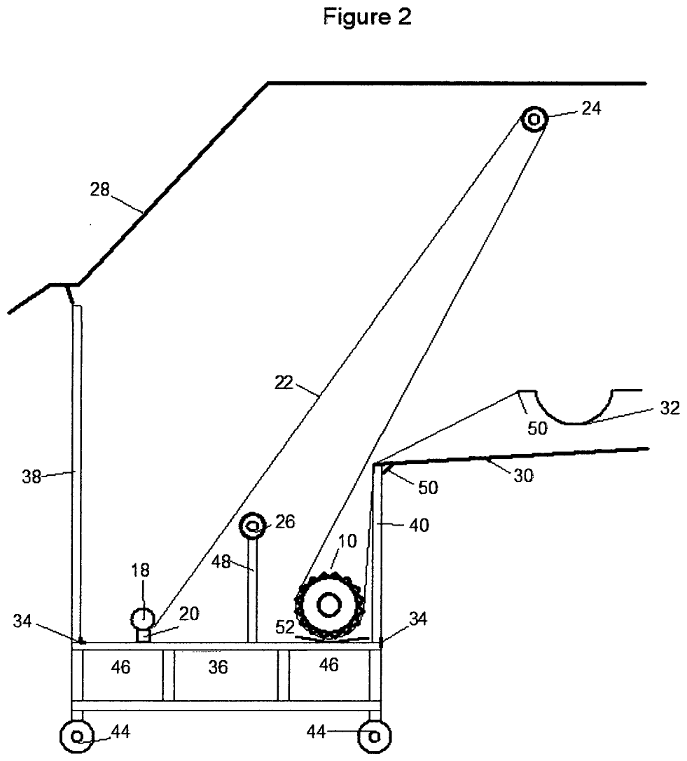

FIG. 2 is a side view of the right rear of a harvester with a discharge beater, 10, removal tool and cart, 36, showing the beater, 10, in the lowered position.

Once the discharge beater, 10, has been removed from its installed location in the rear of the combine, it is lowered to the beater cradle, 52 on the cart, 36. The beater cradle, 52, is designed to hold the beater, 10, in a stable position until it is lowered to the floor. The beater cradle is important because the beater, 10, is very heavy and round and can move unexpectedly, rolling, and injuring people or property.

For installation, the beater, 10, is lifted from the beater cradle, 52, on the cart, 36,

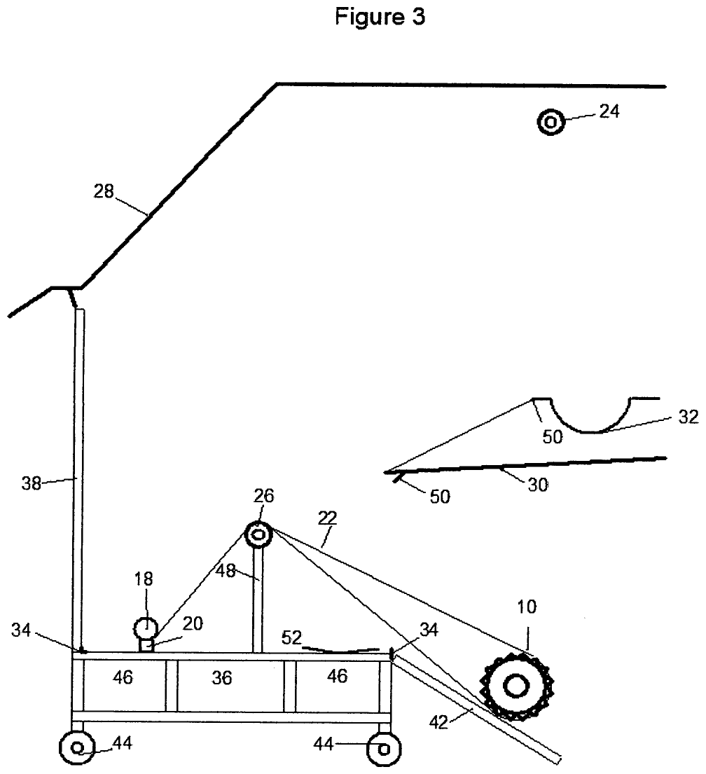

FIG. 3 is a side view of the right rear of a harvester with a discharge beater, 10, removal tool and cart, 36, showing the beater, 10, in the removed position.

Once the beater, 10, has been lowered to the beater cradle, 52, on the cart. The belts, 22, are moved from the upper roller pipe 24 position to the lower roller pipe, 26, position. This permits the winch, 18, to be used to safely lower the beater, 10, to the floor. The reverse of this process starts the beater, 10, on its way back to being installed in the rear of the combine.

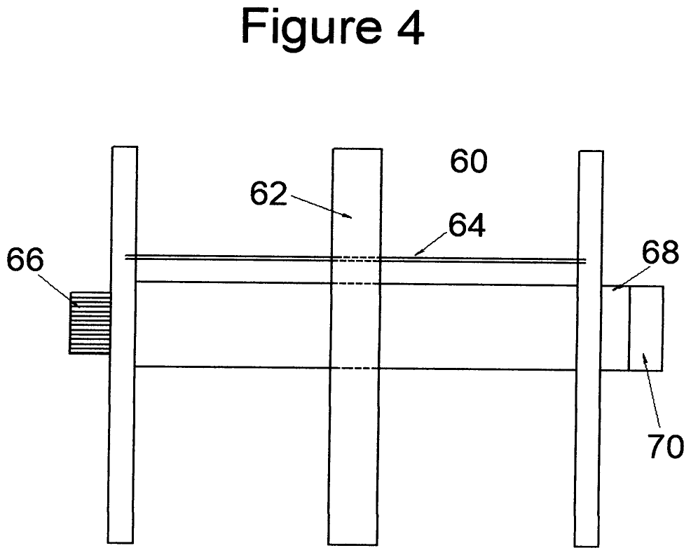

FIG. 4 is a front view of a two-section drum, 60. In a preferred embodiment of the present invention, a drum is equipped with a collar, 62. The collar, 62, can be adjustable or not. The collar 62 can be adjustably or permanently attached. Adjustably attached permits adjusting the drum, 60, to fit various size belts, 22. If the collar, 62, is removeably attached, the winch, 18, drum, 60 can be used with a single larger belt, 22 if required.

The belts, 22, are attached to the drum, 60 with a hold-down wire, 64. This hold-down wire, 64, securely attaches the belts, 22, to the drum, 60.

The drum, 60 is equipped with a planetary gear, 66, drive system on one end to increase the winch's power, 18. The drum, 60, is equipped at the opposite end with a braking system, 68, so that if the power failed, the load would not be dropped.

To ease getting belts, 22 into position, a free spool clutch, 70, is installed. This permits the operator to get the belts quickly and easily, 22, into position before applying power to the winch, 18.

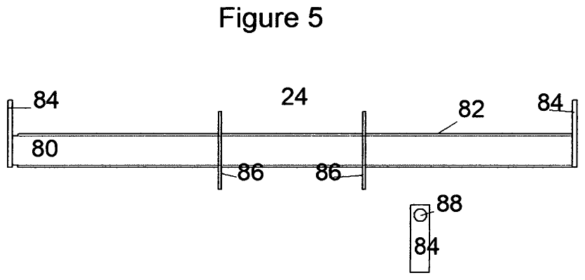

FIG. 5 is a front and end view of a roller pipe, 24. The roller pipe, 24, is used to create a lifting point from which the belts, 22, can lift the beater, 10.

The roller pipe, 24, is adjustable, consisting of two main parts. An inside shaft, 80 and external sleave, 82. These two pieces can be slid in or out to achieve the proper width desired.

The inside shaft, 80, and the external sleeve, 82, have a mounting tab, 84 weldably affixed to one end. This mounting tab, 84, has a mounting hole, 88 in it, to place a bolt (not shown) through when mounting.

The roller pipe, 24, is equipped with two adjustable collars, 86, for use in guiding the belts, 22, when lifting.

Since other modifications and changes varied to fit particular operating requirements and environments will be apparent to those skilled in the art, the invention is not considered limited to the example chosen for disclosure purposes. Instead, it covers all changes and modifications that do not constitute departures from this invention's true spirit and scope.

Having thus described the invention, what is desired to be protected by Letters Patent is presented in the subsequently appended claims.

What is claimed is:

1. A discharge beater removal install device for removal or install in the thrashing system of a discharge beater, comprising:
Means for lifting the discharge beater from its cradle, transporting it out of the machine, and lowering it to a work cart or floor;
means for causing the lifting action through remote control of a winch;
means for permitting the operator to remain safely away from the heavy discharge beater while removing it out the rear of the harvester;
means for replacing the discharge beater into the harvester;
means for causing the removal or installation of the discharge beater without disassembly of the discharge beater itself;
means for attaching the winch portion securely to a solid fixture with various shaped adapters and brackets;
and
means for providing a transport cart to facilitate movement and replacement of parts.

2. The discharge beater removal install device in accordance with claim 1, wherein said means for removing the discharge beater from a harvester comprises at least one winch with at least one belt and at least one roll pipe.

3. The discharge beater removal install device in accordance with claim 1, wherein said means for causing the discharge beater to be removed to a transport cart consisting of at least 3 wheels, a strong, rigid frame, and cradle to securely hold the discharge beater.

4. The Discharge beater removal install device in accordance with claim 1, wherein said means for permitting the operator to control the lifting and lowering of the discharge beater by remote means.

5. The Discharge beater removal install device in accordance with claim 1, wherein said means for lifting and lowering of the discharge beater is based on one or more belts being positioned to securely lift and lower the discharge beater.

6. A discharge beater removal install device for removal or install in the thrashing system of a harvester, comprising:
Means for lifting the discharge beater from its cradle, transporting it out of the machine, and lowering it to a work cart or floor;
means for causing the lifting action through remote control of the winch;
means for permitting the operator to remain safely away from the heavy discharge beater while removing it out the rear of the harvester;
means for replacing the discharge beater into the harvester;
means for causing the removal or installation of the discharge beater without disassembly of the discharge beater itself; and
means for attaching the winch portion securely to a solid fixture with various shaped adapters and brackets;

7. A discharge beater removal install device for removal or install in the thrashing system of a harvester, comprising:
Means for lifting the discharge beater from its cradle, transporting it out of the machine, and lowering it to a work cart or floor;
means for causing the lifting action through remote control of the winch;
means for replacing the discharge beater into the harvester;
means for causing the removal or installation of the discharge beater without disassembly of the discharge beater itself;
means for attaching the winch portion securely to a solid fixture with various shaped adapters and brackets;
means for attaching at least one belt to the winch drum means for causing a winch drum to have separate areas for multiple belts;
means for an adjustable roll pipe for providing a lifting point;
and
means for providing a transport cart to facilitate movement and replacement of parts.
